(19) United States
(12) Patent Application Publication
(10) Pub. No.: US 2010/0240315 A1
(43) Pub. Date: Sep. 23, 2010

(54) METHOD AND SYSTEM FOR SUPPORTING THE SEARCH FOR A MOBILE STATION

(76) Inventors: Fredrik Tufvesson, Lund (SE); Fredrik Thorsell, Stockholm (SE); Marcus Blom, Vasteras (SE)

Correspondence Address: HARNESS, DICKEY & PIERCE, P.L.C., P.O. BOX 8910, RESTON, VA, 20195, US

(21) Appl. No.: 12/452,726

(22) PCT Filed: Jul. 16, 2008
(86) PCT No.: PCT/EP2008/059261

§ 371 Date: May 26, 2010

Related U.S. Application Data
(60) Provisional application No. 60/968,891, filed on Aug. 30, 2007.

(30) Foreign Application Priority Data
Jul. 20, 2007 (SE) 0701767-6

(51) Int. Cl. H04B 17/00

(52) U.S. Cl. 455/67.11

(57) ABSTRACT

A method, a system, a base unit and a search unit are disclosed for locating unknown cellular telephones and guiding the search for such devices. By way of base station functionality in the base unit, mobile stations in a search area are identified and assigned dedicated communication channels. In at least one embodiment, this is achieved through establishing communication between the base unit and the mobile stations in the search area. Search information concerning the mobile stations in the search area is established in the base unit. The search information is transferred from the base unit to the search unit. A search based on the search information is initiated with the search unit.

### FIELD OF INVENTION

The invention relates to a method, a system and devices for supporting the search for a wireless device. More specifically the invention relates to a method, a system, a base unit and a search unit for locating unknown cellular telephones and guiding the search for such devices.

### BACKGROUND OF INVENTION

Locating wireless devices using the emitted radio waves is a well known technique. By means of some kind of directional antenna, it is possible to find the direction to the source, and thereby the location of the device. Similarly, by measuring the time difference for the signal to reach a multiple of receivers it is possible to determine the distance to the source and by simple trigonometry or more advanced parameter estimation algorithms it is possible to estimate the location of the source, see e.g. the book “Wireless Communications” by A. F. Molisch, Wiley, U.K. 2005.

The location systems can, e.g., be used to find people buried in rubble or snow. For the latter there are two dominating techniques: using an active radio device where the emitted radio signal is detected or a passive device that changes the characteristics of a radio signal transmitted by the rescue crew.

The active avalanche beacons are effective for locating people buried in snow, and since the devices both can work as transmitter and as receiver, the search can start immediately if there are persons in the vicinity wearing such a device not captured by the avalanche.

Another method for locating people buried in, e.g., snow, is based on a passive device that alters the characteristics of a transmitted radio signal, often by some kind of non-linear behavior as used in U.S. Pat. No. 4,331,957. The reflector is a small antenna and a non-linear component adding a second harmonic to the received signal before reflecting it back. This second harmonic can then be detected by the search device that also transmits the original signal. For a passive reflector there is no need for any power supply and the size of the reflector can be small. For active radio based positioning, any radio transmitter can in principle be used. There are many proposals for systems, aimed to locate active cellular phones, see e.g. U.S. Pat. No. 6,141,558 when a call or call attempt is made. During a call the cellular phone continuously transmits (often bursts of) radio signals that can be detected and the direction or location of the device can thereby be found by use of some direction finding device. If the identity of the device is known the cellular system can initiate communication with the cellular phone, but most often the identities are not known for people buried, e.g. in snow or rubble.

As described above it is possible to use a radio device for determining the location of, e.g. people buried in snow or rubble. Though current based methods based on active beacons or passive reflectors work well, they are not in widespread use and therefore not of help in many rescue operations and, in case of an active beacon, it must be powered in order to enable the search operation.

ES02156552A1 presents a method to detect unknown cellular phones by forcing them to change base station so that the cellular phone transmits a “location update” message that can be detected by a receiver. This method aims at detecting activated (powered) cellular phones in areas with some kind of restriction for cellular traffic, e.g. in airplanes or hospitals. This method, however, is not well suited for locating the cellular phone in a search operation in an efficient way, since the main goal with this system is to determine whether there are active cellular phones in the coverage area of the system but not to exactly locate them. The fact that there is only a single location update message transmitted, see “Experimental real-time detector of GSM terminals” by Vales-Alonso et al, IEEE Communications Letters, Vol. 7, Issue 3, pp 148-149, 2003, makes a location process impractical.

Other more widespread radio devices, e.g. cellular phones, can also be used for determining the location and thereby be helpful in rescue operations. The problem with today's techniques based on cellular phones can be summarized by one or several of the following drawbacks:

the user has to initiate a call, and this is not possible in many cases;

the identity of the cellular device has to be known;

they do not give satisfactory accuracy in the estimate of the location;

they are dependent on access to the control center of the cellular network; or

they can only detect but not locate the cellular phone.

### SUMMARY OF THE INVENTION

The purpose of the invention is to support the search for mobile stations. The invention is especially useful in an avalanche situation, where avalanche victims need to be located. The invention supports the search for such victims by providing a transportable base unit and one or several search units that communicate with said base unit.

The invention relates in one aspect to a method for supporting a search for at least one mobile station operating in the radio frequency domain. The method involves at least one search unit that comprises an antenna arrangement and a base unit that is adapted to communicate with mobile stations within an area to be searched.

By means of base station functionality in the base unit mobile stations in the search area are identified and assigned dedicated communication channels. This is achieved through establishing communication between the base unit and the mobile stations in the search area. Search information comprising mobile station identity and corresponding dedicated channel for each mobile station in the search area is established in the base unit. The search information concerning the mobile stations in the search area is transferred from the base unit to the at least one search unit.

The search information concerning at least one of the mobile stations in the search area is presented in the at least one search unit. A search based on the presented search information for at least one of the mobile stations in the search area is initiated with the at least one search unit.

In a second aspect, the invention relates to a system for supporting a search for at least one mobile station operating in the radio frequency domain. The system comprises a transportable base unit which in turn comprises an antenna arrangement, radio means, a user interface, a wireless interface, a database, and computer means. The base unit is adapted to communicate with mobile stations within an area to be searched.

The system also comprises at least one search unit which in turn comprises an antenna arrangement, a user interface, a wireless interface, and logic means.

The base unit computer means is adapted to identify mobile stations in the search area and dedicate communication channels for the mobile stations by means of base station functionality. This is done by establishing communication between the base unit and the mobile stations in the search area by means of the antenna arrangement and the radio means.

The base unit is also adapted to establish search information regarding each of the mobile stations in the search area in its database, whereby the search information comprises the identity and the dedicated channel for each mobile station in the search area.

Furthermore, the base unit is adapted to transfer the search information concerning the mobile stations in the search area to the at least one search unit by means of the wireless interface.

The at least one search unit is adapted to receive the search information concerning the mobile stations in the search area from the base unit by means of the wireless interface in the search unit.

The at least one search unit is further adapted to present search information concerning at least one of the mobile stations in the search area by means of the user interface.

Finally, the at least one search unit is adapted to initiate and support a search based on the presented search information for at least one of the mobile stations in the search area by means of the antenna arrangement and the logic means that is adapted to receive control signals from the user interface in the search unit.

According to a third aspect of the invention a base unit for supporting a search for at least one mobile station operating in the radio frequency domain is provided. The base unit comprises an antenna arrangement, radio means, a user interface, a wireless interface, a database, and computer means. The base unit is adapted to communicate with mobile stations operating in the radio frequency domain within an area to be searched.

The base unit computer means is adapted to identify mobile stations in the search area and dedicate communication channels for said mobile stations by means of base station functionality. This is achieved by establishing communication between the base unit and the mobile stations in the search area by means of the antenna arrangement and the radio means.

In addition, the base unit is adapted to establish search information in the database regarding each of the mobile stations in the search area. The search information comprises identity and dedicated channel for each mobile station in the search area.

The base unit is also adapted to transfer the search information concerning the mobile stations in the search area to at least one search device. This is done by means of the wireless interface.

In a fourth aspect, the invention relates to a search unit for supporting a search for at least one mobile station operating in the radio frequency domain, whereby the search unit comprises an antenna arrangement, a user interface, a wireless interface, and logic means.

The search unit is adapted to receive search information concerning the mobile stations in a search area from a base unit by means of the wireless interface in the search unit. By means of the user interface, the search unit is further adapted to present search information concerning at least one of the mobile stations in the search area.

Also, the search unit is adapted to initiate and support a search based on the presented search information for at least one of the mobile stations in the search area by means of the antenna arrangement and the logic means that is adapted to receive control signals from the user interface.

Further embodiments of the invention are specified in the description and the depending claims.

The method and system according to the invention provide a number of advantages. Examples of such advantages are that:

the functionality of the base unit can be maintained at a minimum level, for instance since communication with any unknown mobile station does not require setup and use of authentication or encryption;

distinguishing the mobile stations by allotting them different channels allows the hardware requirements of the search units to be low, since the search units do not need to fully interpret the transmitted signals but only keep track of the channels;

the system does not require a potential victim to take any action in order to be found;

the system will give rescue workers the possibility to use radio based estimation of the location to find all victims wearing a GSM compatible phone (also including UMTS phones that has GSM functionality);

the technology is compatible with all generic GSM mobile stations (GSM phone+SIM card) of which there are presently more than 2 000 000 000 and rising throughout the world;

the system does not require the presence of other base stations or the cooperation of network operators;

the system does not interfere with other avalanche rescue systems;

the system is not limited to use within avalanche rescue. All applications where all mobile stations present in an area need to be counted, forced to transmit or even need to receive a message without the presence of base stations or the cooperation of operators is possible with the proposed system; and

the technology used is well known and well spread.

Further advantages and objects with the present invention will be described in more detail, inter alia with reference to the accompanying drawings.

### BRIEF DESCRIPTION OF THE DRAWINGS

FIG. 1 shows a schematic block diagram of a system according to the invention;

FIG. 2 shows a block diagram of an example extract of the signalling between a base unit and a mobile station;

FIG. 3 shows a block diagram of the general flow of a method according to the invention; and

FIG. 4 shows a map over an example scenario in which the invention can be used.

### DETAILED DESCRIPTION OF THE INVENTION

In the following the invention will be described in more detail by reference to the corresponding drawings.

Among others the following abbreviations will be used in the description below.

PLMN: Public Land Mobile Network

IMSI: International Mobile Subscriber Identity

TIMSI: Temporary International Mobile Subscriber Identity

BCH: Broadcast CHannel

RACH: Random Access CHannel

AGCH: Access Granted CHannel

SDCCH: Stand-alone Dedicated Control CHannel

LAI: Location Area Identity

LU: Location Update

The following examples are intended to illustrate, but not to limit, the invention in any manner, shape, or form, either explicitly or implicitly.

The system comprises a central unit, the base unit, and at least one hand held search unit. The base unit mimics the behavior of a base station and forces all the mobile stations within a specified radius to transmit. The search units are then used to locate the phones by radio based estimation of the direction once they are transmitting.

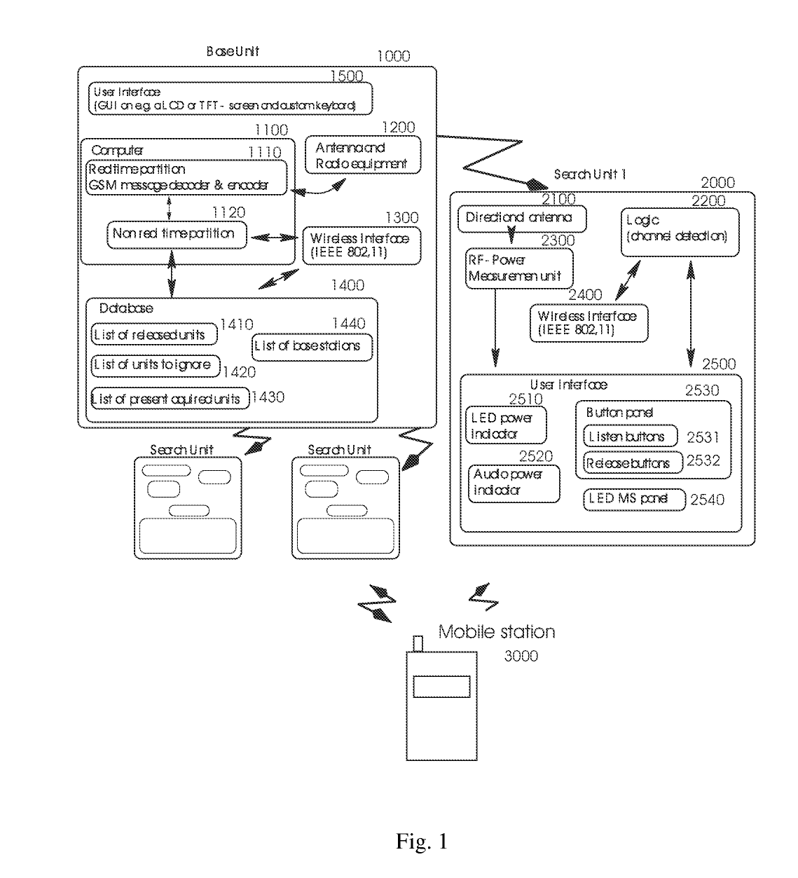

FIG. 1 shows an embodiment of the system according to the invention.

The base unit 1000 is the central unit communicating with both the mobile stations 3000 (e.g., GSM cell-phone and SIM card) and all the search units 2000 being used in the rescue operation. In order to simplify, only one mobile station 3000 is shown in FIG. 1. However, the system according to the invention can be used to support the search for any number of mobile stations 3000. The base unit 1000 will look like a regular base station to a mobile station 3000. In reality the functionality of the base unit 1000 is very limited. The base unit 1000 have the possibility to in real time modulate and demodulate signals that are used for GSM. Apart from comprising functionality for the GSM standard, including the PCS and DCS bands, the base unit 1000 may have the possibility to handle other cellular communication standards, such as WCDMA, CDMA2000, and IS-95. The base unit 1000 comprises an antenna arrangement and radio means, which are represented by the antenna and radio equipment 1200 in FIG. 1. The base unit 1000 also has computer means in the form of a computer 1100, which could be implemented for instance as a microprocessor, a CPU, or similar processing means that also comprises input/output means and data storage means or memory means. The computer 1100 comprises a real time partition 1110 controlling the GSM signaling, and a non real time partition 1120 for controlling a small data base 1400, which is located in a computer readable storage, as well as a wireless interface 1300 that functions as communication means. The wireless interface 1300, which comprises a transceiver, is for communicating with search units 2000. For this interface 1300 the well known IEEE 802.11 standards are used since these give the required coverage and are easy to deploy. The computer 1100 controls the wireless interface 1300 to send information containing all acquired mobile stations' 3000 assigned channels from the data base 1400 to the search unit 2000. It will also update the data base 1400 with release orders from the search units 2000. This communication is handled by the computers 1100 non real time partition 1120. The data base 1400 contains a number of lists, such as lists 1430 of currently acquired mobile stations 3000 containing their allotted channels, a list 1410 of all released mobile stations 3000, a list 1420 of mobile stations 3000 to ignore and a list 1440 of base stations (not shown) present in the area with information about measured RF power from each base station. The list 1420 of mobile stations 3000 to ignore can be initially established in the base unit 1000 prior to setting up the system in the search area. All mobile stations 3000 that are to be excluded from the search can be kept in the ignore list 1420, including mobile stations 3000 carried by rescue personnel. The list 1410 of mobile stations 3000 to release is monitored by the non real time computer partition 1120 of the base unit 1000 and if an addition is made to the list 1410, the mobile station 3000 added is released. A user of any search unit 2000 can add any mobile station 3000 present in the list 1430 of acquired mobile stations 3000 to the release list 1410.

The base unit 1000 is preferably transportable. It may be designed to be easily carried by a single person. The base unit 1000 also has a user interface 1500 that comprises for instance a LCD or TFT screen and a custom keyboard. The user interface 1500 is used for all necessary manual actions that can be carried out on the base unit 1000. The user interface 1500 is connected to the computer 1100.

The main building blocks of the search unit 2000 are an antenna arrangement in the form of a highly directive antenna 2100, and RF electronics (RF power measurement unit) 2300 for locking to one or several communication channels, e.g. a time-frequency slot in the case of GSM, and to measure received power from an arbitrary set of channels. The search unit 2000 also contains a wireless interface 2400 that functions as communication means to communicate with the base unit 1000 and to transfer information to the base unit (1000). The wireless interface 2400 is controlled by logic means in the form of a logic unit 2200 which also controls the RF power measurement unit 2300. The logic unit 2200 is a control unit that can be implemented for instance as a microprocessor, a CPU, or similar processing means that also comprises input/output means and data storage means or memory means. The logic unit 2200 of the search unit 2000 only needs to send and receive a limited number of predefined messages to the wireless interface 2400 as well as controlling the RF power measurement unit 2300 to measure any subset of channels. The search unit 2000 also has a user interface 2500 to present measured power and to allow a search unit 2000 user to control which of the mobile stations 3000 the search unit 2000 should measure and which of the mobile stations 3000 the base unit 1000 should release. The user also have the possibility to tell the base unit 1000 to end or to resume the communication with specified mobile stations 3000, by transferring search results comprising at least one mobile station (3000) identity to the base unit (1000) by means of the wireless interface (2400). The user interface 2500 may, e.g., consist of a LED mobile station panel 2540 showing the actual mobile station 3000 (or mobile stations 3000) for which the power is presented, a button panel 2530, a LED RF power indicator a 2510 and an audio RF power indicator 2520. The LED mobile station panel 2540 may, e.g., have 2 LEDs for each mobile station 3000. One LED indicating that the mobile station 3000 is acquired and is transmitting, the other to show if the search unit 2000 is set to measure the power from that mobile station 3000. For each mobile station 3000 LED pair there can, e.g., be two buttons. One button 2532 for sending a release message to the base unit 1000 instructing it to release the mobile station 3000 or to resume communication if it is in a released state and one button 2531 to turn on/off measurement of RF power on the channel allotted to the mobile station 3000. The information sent to the base unit 1000 is sent by the logic unit 2200 via the wireless interface 2400.

In the following section the system is described as it will work for the GSM system. It may have similar functionality for other standards, though the naming convention is different for those.

The base unit 1000 triggers mobile stations 3000 within a search area to start transmit and then handles all the communication with the mobile stations 3000 in its area. The base unit 1000 is placed somewhere overlooking the entire search area. The output power of the base unit 1000 can be set at different levels by means of the user interface 1500. The power output level defines the size of the area that is to be searched. When starting the rescue operation the base unit 1000 scans the entire spectrum used for cellular services to determine whether there are neighboring base stations. This is done by the antenna and radio equipment 1200. The non real time computer partition 1120 determines which, if any, detected base stations that are WCDMA stations, which are GSM stations or if they use any other cellular standard. The system stores the detected power levels in the data base 1400 list 1440 of base stations since these later will be used as a basis for the jamming power transmitted by the radio equipment 1200, which comprises jamming means that may be controlled by the computer 1100, when jamming present base stations.

If base stations are detected, the system starts to jam their BCH signaling carriers, this is also performed by the antenna and radio equipment 1200. A new base station is then emulated by the base unit 1000. The emulation is done by the antenna and radio equipment block 1200 controlled by the real time computer partition 1110 using data from the non real time computer partition 1120. It then starts transmitting on any of the available BCH channels with a unique LAI. When the mobile stations 3000 can not maintain or establish communication with the base stations in their regular network they will find this new carrier and synchronize to it. Recognizing that it is a new LAI the mobile stations 3000 will try to make a location update (LU). During the communication when the mobile stations 3000 try to make a LU they send a random number in an access burst. This number is recognized by the real time computer partition 1110 and used to address the mobile station 3000 and to distinguish it from other mobile stations 3000, i.e. the random number identifies the mobile station 3000. The real time computer partition 1110 now starts to control the communication with the mobile stations 3000 through the antenna and radio equipment 1200 in order to trigger them to transmit radio signals that make them detectable. Each mobile station 3000 is allotted a unique channel (e.g., frequency and timeslot in the case of GSM), by the real time computer partition 1110. The channel together with the random number is all that is required by the system to distinguish between the mobile stations 3000. Information about unused channels is sent from the non real time computer partition 1120 to the real time computer partition 1110. When all the mobile stations 3000 are allotted a channel, the radio equipment 1200 stops jamming the other BCH carriers, without the mobile stations 3000 attempting to switch back to their previous possible base stations. All GSM signaling above is composed and timed by the real time computer partition 1110, modulated by the radio electronics in the antenna and radio equipment 1200.

The non real time computer partition 1120 now starts the process to communicate the number of mobile stations 3000, including their respective identities, in the area to the one or several search units 2000 using the wireless interface 2400. It also communicates the channels where they are transmitting. This data will be used as search information which is transferred from the base unit 1000 to the at least one search unit 2000. Each search unit 2000 can receive this search information from the base unit 1000 by means of the wireless interface 2400. The search units 2000 may now choose to listen to all channels that are allotted to the mobile stations 3000 by the base unit 1000, to only one single channel or to any combination of channels. This is done by the logic unit 2200 by sending the proper instructions to the RF power measurement unit 2300. This allows the rescue team to better organize the search. The search units 2000 will now measure the RF signal strength which will be relayed to the search unit 2000 user by, e.g., the volume of an audio tone 2520 and/or by LED power indicator 2510.

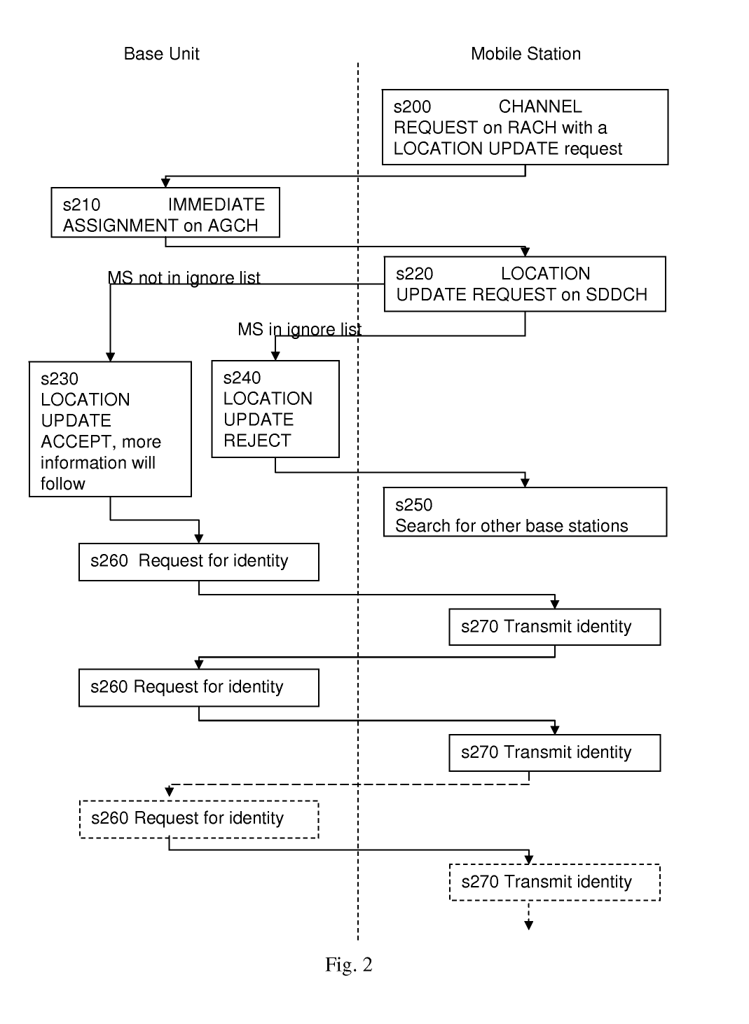

To further illustrate the invention, FIG. 2 shows a block diagram of the signaling between the base unit 1000 and a mobile station 3000.

The following steps that are shown in FIG. 2 are now carried out: In s200 the mobile station 3000 sends a CHANNEL REQUEST message on the RACH channel to the base unit 1000 with the request LOCATION UPDATE. The base unit 1000 responds in s210 with an IMMEDIATE ASSIGNMENT message over the AGCH channel. The channel granted is a SDCCH channel. The mobile station 3000 will now be in dedicated mode which means that the mobile station 3000 will not change base station.

In s220 the mobile station 3000 sends LOCATION UPDATE REQUEST message to the base unit 1000 over the SDDCH channel containing among other things its identity, which could be for instance the IMSI number or the TIMSI number.

Now one of two things will happen depending on a check of the mobile station's 3000 identity against a list of mobile stations 3000 to be ignored by the base unit 1000 (kept in the base unit's 1000 data bases 1400 list of units to ignore 1420). Throughout the search the identities of mobile stations 3000 in the search area are compared with the mobile stations 3000 in the ignore list 1420. If the mobile station's 3000 identity is in the ignore list 1420, a LOCATION UPDATE REJECT message is sent to the mobile station 3000. This is done in s240. The message states that this PLMN is not allowed for the mobile station 3000. The mobile station 3000 will then in s250 try to camp on another base station, i.e. its previous base station in the regular cellular network. Throughout the search communication with mobile stations 3000 that are registered in said ignore list 1420 will be terminated by the base unit 1000. This will be done continuously as new mobile stations 3000 are added to the ignore list 1420.

If the identity is not in the ignore list 1420 a LOCATION UPDATE ACCEPT message is sent to the mobile station 3000 in s230. In the message it is stated that more messages will follow.

Then connections between the base unit 1000 and the mobile stations 3000 are established, whereby the base unit 1000 and the mobile stations 3000 communicate in such a way that the mobile stations 3000 can be forced to continuously transmit radio bursts. The base unit 1000 may keep the mobile stations 3000 in dedicated mode by keep telling them that more information will follow thus making them searchable. The search units 2000 can during this time search for the mobile station's 3000 radio signal on the SDCCH in the search area.

One exemplifying way of achieving this is to have the base unit 1000 to transmit an IDENTITY REQUEST message to the mobile station 3000 in which it is specified that it is the IMSI number that is requested. This is done in s260. In s270 the mobile station 3000 then responds to the base unit 1000 with a IDENTITY RESPONSE message containing its IMSI number.

The last two steps, s260 and s270, can be repeated to ensure that the mobile station 3000 continuously transmits data and that it does not change mode to idle in which it can change base station. The rescue units will during this time look for the mobile stations 3000 in the search area. Communication between the base unit 1000 and the mobile stations 3000 is maintained until all mobile stations 3000 in the search area have been accounted for.

Similarly, the base unit 1000 may proceed in the LOCATION UPDATE sequence, which is defined in the GSM standard, to force continuous transmission of radio bursts after the mobile station 3000 has camped on the base unit 1000. This can for example be achieved by transmitting repetitive PAGING REQUEST messages to the mobile station/stations 3000 of interest, or other messages that trigger a response from the mobile stations 3000. In case of PAGING REQUEST, the mobile stations 3000 addressed will then send PAGING RESPONSE messages to the base unit 1000.

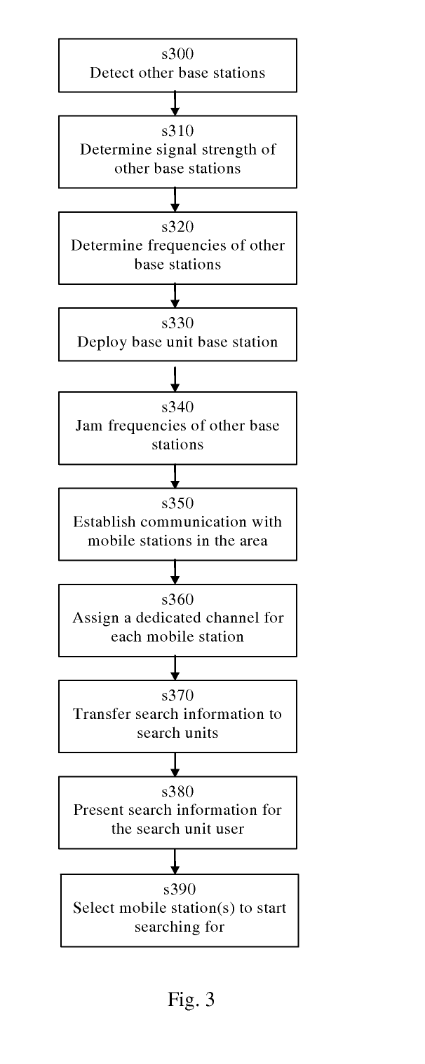

To further illustrate the invention, FIG. 3 shows an example of a general flow of the method for supporting the search for a mobile station.

The flow starts in s300 in which the base unit 1000 of the system detects the possible presence of active base stations of other cellular radio communications networks. If such base stations are present, the base unit 1000 determines their signal strength in s310 as well as the frequencies that are used by those base stations in s320.

In s330 a base station is deployed by the base unit 1000 according to the invention. After deployment, this base station is used to jam the above detected frequencies of other base stations. The next step is to establish communication with all mobile stations 3000 within range of the base unit 1000. This is done in s350. In s360 each mobile station 3000 is assigned a dedicated channel, which will be used throughout the rest of the search flow. Information that will be used during the search is transferred from the base unit 1000 to the search units 2000 in s370.

The search information is presented to the search unit 2000 user in s380, where after the search unit 2000 user selects one of several mobile stations 3000 to search for in s390.

In UMTS there is authentication of base stations which means that information from the operator is required in order to set up a “new” base station. Having this information it is possible to use a similar approach in case of UMTS.

In addition, UMTS phones presently developed for the world market (excluding Japan and possibly some other countries) also support the GSM protocol, which means that the presented solution can be used for locating UMTS cellular phones. In addition to jamming all GSM stations all present UMTS Node-b's are jammed as well, this is described in “Real-time 3G UMTS terminal detection” by Vales-Alonso et al, IEEE Communications Letters, Vol. 6, Issue 3, pp 123-125, 2002. This is done by using the public codes that are used for all UMTS node b's with a WCDMA transmitter. This forces the phone into GSM mode where it finds the base unit.

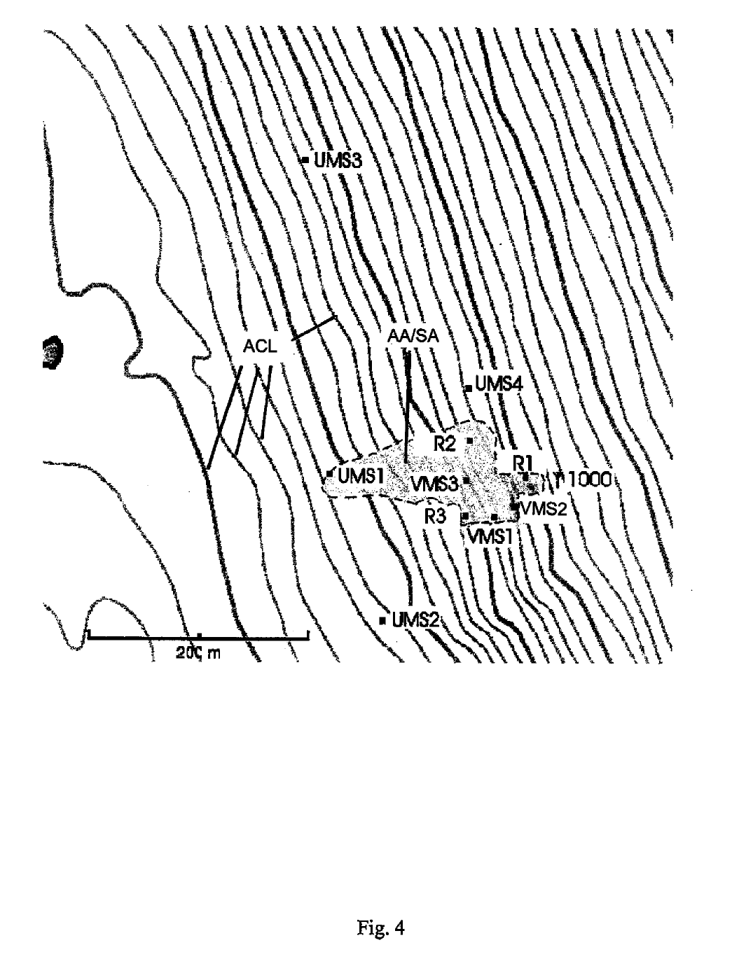

The use and action of the system will be described in an example scenario according to FIG. 4, which shows a map over an area where there has been an avalanche in which three victims are buried. Each victim carries a mobile station that is turned on. A rescue team that reaches the site is three persons strong, whereby each rescue team member carries a search unit as described with reference to FIG. 1 above. In addition to this there are four other mobile station users in the near vicinity.

In FIG. 4 the rescue team search units are represented by RU1, RU2 and RU3. The victim mobile stations are represented by VMS1, VMS2 and VMS3. Mobile stations not in avalanche are represented by UMS1, VMS2, VMS3 and UMS4. A base unit is represented by 1000. The highlighted grey area represented by AA/SA is the avalanche area, which will be searched in this scenario. The curved lines in FIG. 4 are altitude contour lines, of which some are represented by ACL. The altitude contour lines indicate a steep slope in the terrain.

The locations of the involved units are shown in FIG. 4.

The rescue crew arrives at the avalanche deposit and finds a suitable position for a base unit 1000 overlooking the entire search area. The base unit 1000, which has been described with reference to FIG. 1 above, is started by an operator in order to initially detect base stations belonging to possible existing cellular communication networks that might be active in the area.

In this scenario, other cellular communication networks are active in the area, so the base unit 1000 then continues to jam the detected base stations.

All mobile stations, except UMS3 which is to far away from the base unit 1000, will at this point be affected by the jamming. The jamming will cause a downlink failure which will trigger a cell reselection from the mobile stations. This takes at most 5.3 seconds. UMS1 is, at the time the base unit 1000 starts jamming, involved in a phone call that will be terminated.

At the same time as the jamming begins, functionality of a new base station is emulated by the base unit 1000 at a frequency which is not used by other base stations in the area. All mobile stations except UMS3 will try to synchronize to this new base station as soon as they declared their downlink failure with their original base station. The mobile stations see that this base station has a different LAI number than their previous LAI, and this will trigger a location update. The affected mobile stations now request a data channel from the base unit 1000 which assigns one data channel to each mobile station. The mobile stations then send their location update request messages, which contain their identity. The jamming is now aborted after being active for just less than 8 seconds.

The base unit 1000 now has contact with all mobile stations of interest. In order to exclude unwanted mobile stations, the base unit 1000 now sends a broadcast SMS to all phones asking the users to turn off their phones because of an ongoing avalanche rescue operation in progress. Alternatively, a broadcast call can be used to the same effect. Mobile station users can now by restarting their phones acquire a connection to their regular base stations. All the phones now communicating with the base unit 1000 will now receive the SMS.

The three avalanche victims are unable or unwilling to turn off their phones and so is UMS4. UMS1 and UMS2 are however restarted. They will now be removed from the list of present phones, as has been described above with reference to FIG. 2, and reconnects to their preferred base station.

The rescue crew now starts scanning the search area with the aid of the search units. Messages that need to be exchanged between the search unit operators during the search can be transferred orally, for instance by means of the search unit, which can comprise walkie-talkie, push-to-talk, or similar functionality. This functionality can for instance be incorporated into the wireless interface 2400 that has been described above with reference to FIG. 1. Also, the wireless interface 1300 in the base unit 1000 may comprise a similar function.

RU1 detects the signal from VMS1 and RU1 is set by its operator to listen for only VMS1. RU2 now also detects VMS1 but when the operators of the other search units are asked if any of them are searching for VMS1, the operator of RU1 says that he/she already is searching for that victim and that victim is excluded by the operator of RU2 from his/her list of measured mobile stations. This is achieved by means of the user interface 2500 in the search unit. Instead UMS4 is found by RU2 and RU2 is set by its operator to listen for only UMS4. VMS2 is detected by RU3 and RU3 is set by its operator to listen only for VMS2. RU2 searches for UMS4, which is found by the operator of RU2 to not be a victim. Adding UMS4 to an ignore list 1420, as has been described above with reference to FIG. 1, is then inititiated by the operator of RU2, by transferring data informing of the located UMS4 to the base unit 1000. The base unit 1000 updates the ignore list 1420 and the search information, and transfers the updated search information to the search units that are carried by the rescue team members. The operator of RU2 is now told by his colleagues that only VMS3 is not being looked for. The base unit 1000 closes the connection to UMS4 which now searches for and finds its old base station.

The rescue crew now proceeds to find their respective victims.

Once a victim is rescued, its mobile station is added to the ignore list 1420 in the base unit 1000 in order to make the search of the remaining victims as efficient as possible. The rescue crew continues the search until all victims are located.

Examples of further advantages that are provided by the invention include:

the system can establish and maintain communication with any unknown mobile station, also when there are other base stations in the vicinity;

the system is independent of possible cellular network infrastructure and operators, and works both where there is cellular coverage and where there is not;

the mobile stations can be forced to transmit often enough (at least several times per second) to make efficient manual search possible;

jamming of possible other active base stations is only done during an initial short period of time after which the system will work without interfering with other radio traffic;

the system can call or send informative SMS messages urging the user to restart their mobile stations for it to work properly again, which means that mobile stations not carried by victims can be removed from the search and that the disturbance to regular cellular radio traffic can be kept to a minimum;

the system will, based on the size of the search area and the maximum detected base station power, determine an optimum power with which to jam present base stations without transmitting stronger signals than necessary, which keeps interference with regular traffic at a minimum level;

single mobile stations or groups of mobile stations can be distinguished from others when searching;

the system will within a few seconds from being activated give rescue workers a figure of how many phones (possible victims) that are present in the area;

the use of GSM frequencies allows for high directivity antennas to be used determining the direction to the source. Other avalanche rescue systems use much lower frequencies making directional estimates much harder and much less accurate; and

the system is flexible in that acquired mobile stations can be released at any time while keeping others locked to the base unit.

Although the invention has been disclosed above with reference to examples based on the accompanying drawings, it is obvious that the invention is not restricted thereto, but may vary in many ways within the scope of the accompanying claims.
From the detailed description above that mainly relates to use with the GSM standard, including the PCS and DCS bands, the skilled person will realize that the invention may be applicable for use also with other standards, such as WCDMA, CDMA2000, and IS-95.

1. A method involving at least one search unit that includes an antenna arrangement for supporting a search for at least one mobile station operating in the radio frequency domain; and a base unit that is adapted to communicate with mobile stations within an area to be searched, the method comprising:
identifying mobile stations in the search area;
dedicating communication channels for said mobile stations by way of base station functionality in the base unit, by establishing communication between the base unit and the mobile stations in the search area;
establishing search information in the base unit regarding each of the mobile stations in the search area, whereby the search information includes a mobile station identity and a corresponding dedicated communication channel for each mobile station in the search area;
transferring the search information concerning the mobile stations in the search area from the base unit to the at least one search unit;
presenting the search information concerning at least one of the mobile stations in the search area in the at least one search unit; and
initiating a search based on the presented search information for at least one of the mobile stations in the search area with the at least one search unit.

2. A method according to claim 1, further comprising detecting base stations of possible other active cellular radio communications networks in the search area with the base unit.

3. A method according to claim 2, further comprising determining the signal strength of possible other active cellular radio communications networks in the search area with the base unit.

4. A method according to claim 1, further comprising determining, in the base unit, which frequencies that are used by the base stations of possible other cellular radio communications networks that are active in the search area.

5. A method according to claim 4, further comprising jamming the determined frequencies with the base unit so that mobile stations in the search area can not communicate with said other cellular radio communications networks.

6. A method according to claim 3, further comprising establishing communication between the base unit and the mobile stations in the search area by the base unit transmitting a RF signal with a frequency that differs from the frequencies transmitted by the other cellular radio communications network.

7. A method according to claim 25, wherein communication is maintained between the base unit and the mobile stations in the search area by repeatedly performing
sending identity or paging requests from the base unit to the mobile stations in the search area; and
receiving, in the base unit, the identity or paging request standard responses from the mobile stations in the search area.

8. A system for supporting a search for at least one mobile station operating in the radio frequency domain, the system comprising:
a transportable base unit that includes an antenna arrangement, at least one radio device, a user interface, a wireless interface, a database, and at least one computer device, whereby the base unit is adapted to communicate with mobile stations within an area to be searched; and
at least one search unit that includes an antenna arrangement, a user interface, a wireless interface, and at least one logic device, wherein the at least one computer device of the transportable base unit is adapted to identify mobile stations in the search area and dedicate communication channels for said mobile stations by way of base station functionality, by establishing communication between the transportable base unit and the mobile stations in the search area by way of the antenna arrangement and the at least one radio device; wherein the transportable base unit is adapted to establish search information in the database regarding each of the mobile stations in the search area, whereby the search information includes a mobile station identity and a dedicated communication channel for each mobile station in the search area; wherein the transportable base unit is adapted to transfer the search information concerning the mobile stations in the search area to the at least one search unit by way of the wireless interface; wherein the at least one search unit is adapted to receive the search information concerning the mobile stations in the search area from the transportable base unit by way of the wireless interface; wherein the at least one search unit is adapted to present search information concerning at least one of the mobile stations in the search area by way of the user interface; and wherein the at least one search unit is adapted to initiate and support a search based on the presented search information for at least one of the mobile stations in the search area by way of the antenna arrangement and the at least one logic device that is adapted to receive control signals from the user interface.

9. A system according to claim 8, wherein the transportable base unit is adapted to detect base stations of possible other active cellular radio communications networks in the search area.

10. A system according to claim 9, wherein the transportable base unit is adapted to determine the signal strength of possible other active cellular radio communications networks in the search area.

11. A system according to claim 8, wherein the transportable base unit is adapted to determine which frequencies that are used by the base stations of possible other cellular radio communications networks that are active in the search area.

12. A system according to claim 11, wherein the transportable base unit is adapted to jam the above determined frequencies so that mobile stations in the search area cannot communicate with said other cellular radio communications networks.

13. A system according to claim 10, wherein the transportable base unit is adapted to establish communication between the transportable base unit and the mobile stations in the search area by transmitting a RF signal with a frequency that differs from the frequencies transmitted by the other cellular radio communications network.

14. A system according to claim 27, wherein the transportable base unit is adapted to maintain communication with the mobile stations in the search area by repeatedly performing:
sending identity or paging requests to the mobile stations in the search area; and
receiving the identity or paging request standard responses from the mobile stations in the search area.

15. A base unit for supporting a search for at least one mobile station operating in the radio frequency domain and being adapted to communicate with at least one mobile station operating in the radio frequency domain within an area to be searched, the base unit comprising:
an antenna arrangement;
at least one radio device;
a user interface;
a wireless interface;
a database; and
at least one computer device, adapted to identify mobile stations in the search area and dedicate communication channels for said mobile stations by way of base station functionality, by establishing communication between the base unit and the mobile stations in the search area by way of the antenna arrangement and the at least one radio device; wherein the base unit is adapted to establish search information in the database regarding each of the mobile stations in the search area, the search information including a mobile station identity and a dedicated channel for each mobile station in the search area; and wherein the base unit is adapted to transfer the search information concerning the mobile stations in the search area to at least one search unit by way of the wireless interface.

16. A base unit according to claim 15, wherein the base unit is adapted to detect base stations of possible other active cellular radio communications networks in the search area.

17. A base unit according to claim 16, wherein the base unit is adapted to determine the signal strength of possible other active cellular radio communications networks in the search area.

18. A base unit according to claim 15, wherein the base unit is adapted to determine which frequencies that are used by the base stations of possible other cellular radio communications networks that are active in the search area.

19. A base unit according to claim 18, wherein the base unit is adapted to jam the above determined frequencies so that mobile stations in the search area can not communicate with said other cellular radio communications networks.

20. A base unit according to claim 17, wherein the base unit is adapted to establish communication with the mobile stations in the search area by transmitting a RF signal with a frequency that differs from the frequencies transmitted by the other cellular radio communications network.

21. A base unit according to claim 29, wherein the base unit is adapted to maintain communication with the mobile stations in the search area by repeatedly performing:
sending identity or paging requests to the mobile stations in the search area; and
receiving the identity or paging request standard responses from the mobile stations in the search area.

22. A search unit for supporting a search for at least one mobile station operating in the radio frequency domain, the search unit comprising:
an antenna arrangement;
a user interface;
a wireless interface; and
at least one logic device, wherein the search unit is adapted to receive search information concerning the mobile stations in a search area from a base unit by way of the wireless interface; wherein the search information includes a mobile station identity and a dedicated communication channel for each mobile station in the search area; wherein the search unit is adapted to present search information concerning at least one of the mobile stations in the search area by way of the user interface; wherein the search unit is adapted to initiate and support a search based on the presented search information for at least one of the mobile stations in the search area by way of the antenna arrangement and the at least one logic device that is adapted to receive control signals from the user interface; and wherein the search involves causing the search unit to listen to at least one of the dedicated communication channels included in the search information.

23. A search unit according to claim 22, wherein the search unit is adapted to transfer search results and other information to the base unit by way of the wireless interface.

24. A method according to claim 1, wherein communication is maintained between the base unit and the mobile stations in the search area by the base unit forcing the mobile stations to continuously transmit radio bursts.

25. A method according to claim 24, wherein the base unit transmits repetitive messages that trigger a response from the mobile stations in the search area, so as to prevent the mobile stations from entering idle mode in which they would be able to change base station.

26. A system according to claim 8, wherein communication is maintained between the base unit and the mobile stations in the search area by the base unit being adapted to force the mobile stations to continuously transmit radio bursts.

27. A system according to claim 26, wherein the base unit is adapted to transmit repetitive messages that trigger a response from the mobile stations in the search area, so as to prevent the mobile stations from entering idle mode in which they would be able to change base station.

28. A base unit according to claim 15, wherein communication is maintained between the base unit and the mobile stations in the search area by the base unit being adapted to force the mobile stations to continuously transmit radio bursts.

29. A base unit according to claim 25, wherein the base unit is adapted to transmit repetitive messages that trigger a response from the mobile stations in the search area, so as to prevent the mobile stations from entering idle mode in which they would be able to change base station.
